(19) United States
(12) Patent Application Publication
(10) Pub. No.: US 2012/0008241 A1
(43) Pub. Date: Jan. 12, 2012

(54) ESD PROTECTION CIRCUIT AND METHOD

(75) Inventors: Richard Hernandez GARCIA, Singapore (SG); Kian Teck TEO, Singapore (SG); Yoshinori ISHIKAWA, Kyoto (JP); Wee Siong LOW, Singapore (SG); Terence Jin Min LIM, Singapore (SG)

(73) Assignees: PANASONIC SEMICONDUCTOR ASIA PTE., LTD., Singapore (SG); PANASONIC CORPORATION, Osaka (JP)

(21) Appl. No.: 12/830,619

(22) Filed: Jul. 6, 2010

(51) Int. Cl. H02H 9/04

(52) U.S. Cl. 361/56

(57) ABSTRACT

An ESD protection circuit for reducing the regulator output capacitance includes a ground isolation circuit or a VCC isolation circuit to isolate regulator output from ground terminal or VCC terminal whenever ESD occurs, causing dropping of the differential voltage between regulator output and ground. The isolation circuits function to minimize the leakage current.

### BACKGROUND OF THE INVENTION

The present invention relates to a circuit for reducing regulator output capacitor which is used for ESD (electrostatic discharge) spike suppression, and more particularly, to an ESD protection circuit and method.

Referring to FIG. 1; a conventional system 100 comprises power supply terminals VCC 3, ground terminal GND 4, regulator 2 and load circuit 1. Output of regulator 2, namely node 5 supplies an output voltage VREG to load circuit 1, whereby node 5 and ground terminal GND 4 serve as supply rail of load circuit 1.

The ESD occurring at terminals VCC 3 and GND 4 may cause the differential voltage (VREG−GND) to drop. If the differential voltage (VREG−GND) should drop to a voltage below a pre-determined threshold, the load circuit may operate improperly, as the differential voltage (VREG−GND) is the supply of the load circuit.

Referring to FIG. 2; in order to prevent the voltage drop in the differential voltage (VREG−GND), a charge storage device, such as a capacitor 6 is connected to node 5. Capacitor 6 is either implemented internally (in an integrated circuit) or externally. In order to ensure that the differential voltage (VREG−GND) remains above a pre-determined threshold for the duration of the ESD spike, a capacitor with a large capacitance is usually needed.

Some conventional design uses an external capacitor to implement 6. However, the external capacitor is sensitive toward ESD occurrence on application board. Hence, depending on ESD level, in an ESD occurrence on the pin of the external capacitor, the differential voltage (VREG−GND) is possible to drop to a voltage below the pre-determined threshold and thus causing improper operation of load circuit 1.

Due to such consideration, it is desirable to implement the capacitor 6 internally. However, the implementation of such a large capacitance on silicon is difficult and expensive due to the large chip size.

Hence, it is necessary to reduce the needed capacitance of capacitor 6 such that the capacitor 6 has a capacitance sufficiently small to be implemented internally in the IC.

### SUMMARY OF THE INVENTION

The purpose of this invention is to provide an ESD protection circuit which can reduce the capacitance of the output charge storage device of a regulator.

According to the present invention, an electrostatic discharge (ESD) protection circuit for use in a power supply device for supplying a DC power to a load circuit between a first power line and a second power line is disclosed. The ESD protection circuit comprises: a regulator provided between the first power line and the load circuit; a charge storage device inserted between the first power line and the second power line; and a second power line isolation circuit provided between the regulator and the second power line whereby the second power line isolation circuit isolates an output of the regulator from the second power line when an ESD occurs in the second power line, so as to establish a temporary power supply from said charge storage device to the load circuit.

According to the present invention, an electrostatic discharge (ESD) protection circuit for use in a power supply device for supplying a DC power to a load circuit between a first power line and a second power line is disclosed. The ESD protection circuit comprises: a regulator provided between the first power line and the load circuit; a charge storage device inserted between the first power line and the second power line; a second power line isolation circuit provided between the regulator and the second power line whereby the second power line isolation circuit isolates an output of the regulator from the second power line when an ESD occurs in the second power line, so as to establish a temporary power supply from said charge storage device to the load circuit; and a first power line isolation circuit provided between the regulator and the first power line whereby the first power line isolation circuit isolates an output of the regulator from the first power line when an ESD occurs in the first power line, so as to establish a temporary power supply from said charge storage device to the load circuit.

### BRIEF DESCRIPTION OF THE DRAWINGS

FIG. 1 is a block diagram of a conventional system using regulator as power supply for a load circuit.

FIG. 2 is a block diagram of another conventional system using regulator supply for a load circuit with additional capacitor connected at regulator output terminal.

FIG. 3A is a block diagram of an ESD protection circuit according to the first embodiment of the present invention.

FIG. 3B is a block diagram of an ESD protection circuit according to the first embodiment, using a dual power supply system.

FIG. 4A is a circuit diagram of an ESD protection circuit according to the first embodiment of the present invention.

FIG. 4B is a circuit diagram of an ESD protection circuit according to a modification of the first embodiment of the present invention.

FIG. 4C is a circuit diagram showing a detail of bandgap reference voltage circuit (BG).

FIG. 5A is a waveform diagram showing operation of the conventional system during the presence of ESD positive spike at the ground terminal GND.

FIG. 5B is a waveform diagram showing an operation of the first embodiment during the presence of ESD positive spike at the ground terminal GND.

FIG. 5C is a waveform diagram showing operation of the conventional system during the presence of ESD negative spike at the power supply terminal VCC.

FIG. 5D is a waveform diagram showing operation of the second embodiment during the presence of ESD negative spike at the power supply terminal VCC.

FIG. 6 is a block diagram showing a modification of the ESD protection circuit shown in FIG. 3A.

FIG. 7 is a circuit diagram of the ESD protection circuit shown in FIG. 6.

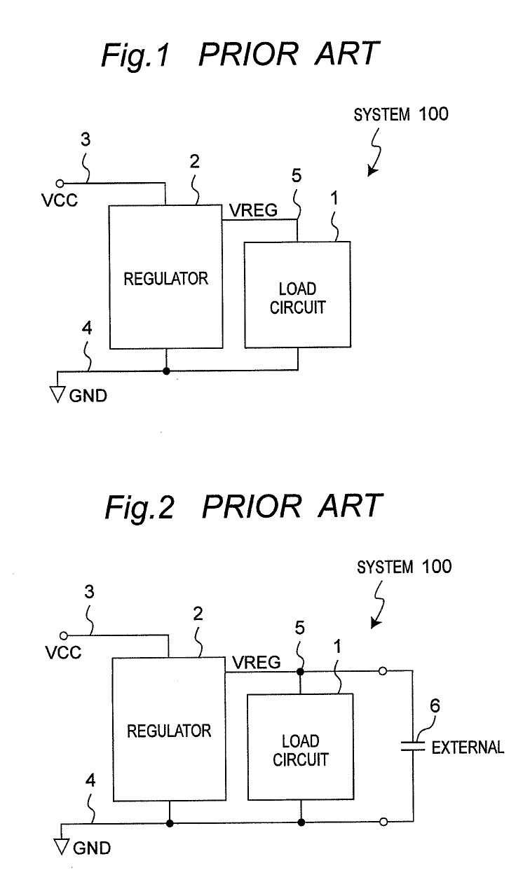

It will be recognized that some or all of the Figures are schematic representations for purposes of illustration and do not necessarily depict the actual relative sizes or locations of the elements shown.

### DETAILED DESCRIPTION OF THE PREFERRED EMBODIMENTS

The following description explains the best mode embodiment of the present invention.

### First Embodiment

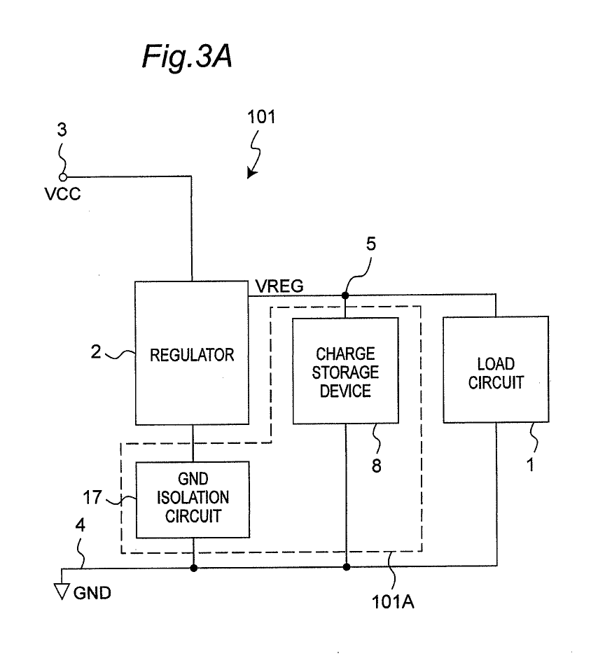

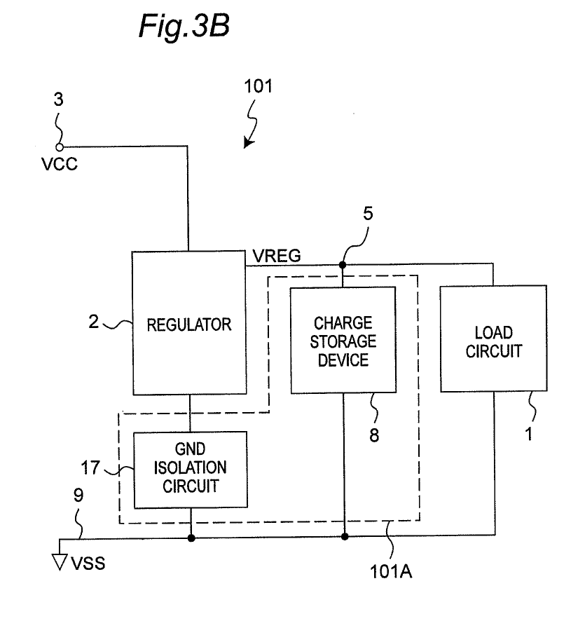

Referring to FIG. 3A, an ESD protection circuit 101A according to a first embodiment is shown for use in a system, such as a DC power supply system 101 which is also a part of the present invention.

The system 101 comprises a power supply line or terminal VCC 3 and a ground line or terminal GND 4, a regulator 2, and a load circuit 1 which is provided, e.g., internally in an integrated circuit. The power line 5 and the ground line 4 serves as the first and second power lines between which the load circuit 1 is inserted. The ESD protection circuit 101A comprises a charge storage device 8 and a ground isolation circuit 17. An output terminal of regulator 2, namely node 5 functions as a DC supply terminal for supplying a voltage VREG to load circuit 1. Although it is mentioned that the system 101 comprises power supply terminal VCC 3 and ground terminal GND 4, it should be emphasized that the present invention is also applicable to a system with dual power supply terminals. Such a system with dual power supply terminals is shown in FIG. 3B, where a dual power supply system has terminals VCC 3 and −VSS 9. The terminal 9 serves as a terminal of the second power line.

The charge storage device 8 is implemented internally in an integrated circuit.

The operation of the first embodiment is described as follows:

Ground Isolation Circuit 17 isolates node 5 from the ground terminal GND 4 during an ESD occurrence. This is to minimize the leakage current from node 5 to ground terminal GND 4 during the ESD occurrence and to slow down the rate of voltage drop at node 5 during an ESD occurrence.

According to the present invention, the charge storage device 8 provided in association with ground isolation circuit 17 prevents the differential voltage (VREG−GND) from being dropped below a pre-determined threshold within a pre-determined period.

Here, the pre-determined threshold is a voltage between the ground level GND and the normal voltage level VREGN at node 5 without any ESD occurrence. According one example, the pre-determined threshold VTH is as follows.

(½)*(VREGN−GND)<VTH<( 9/10) *(VREGN−GND)

Here, (VREGN−GND) is a normal differential voltage.
The predetermined period is a period shorter than a period of presence of the ESD occurrence, such as 1/10−½ of the period of presence of the ESD occurrence.

By the ground isolation circuit 17, it is possible to reduce the capacitance of the charge to be stored in the charge storage device 8.

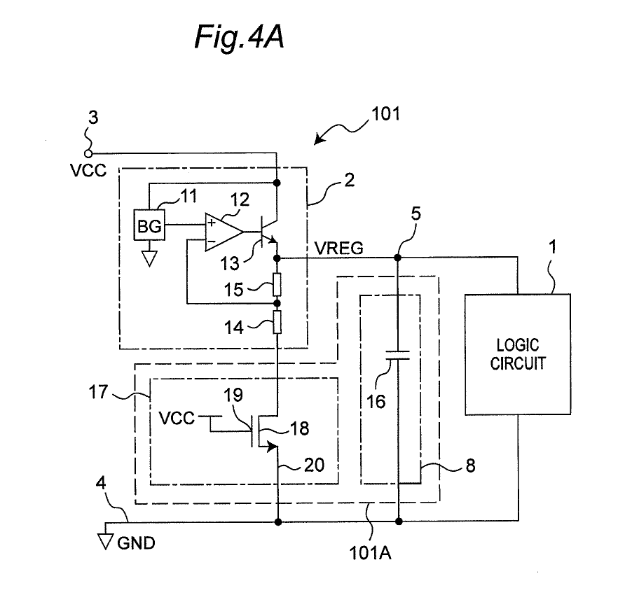

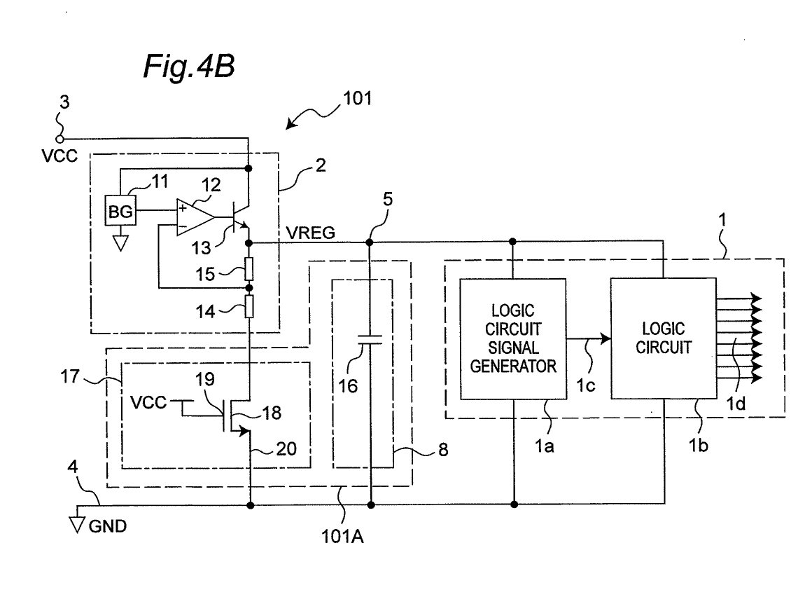

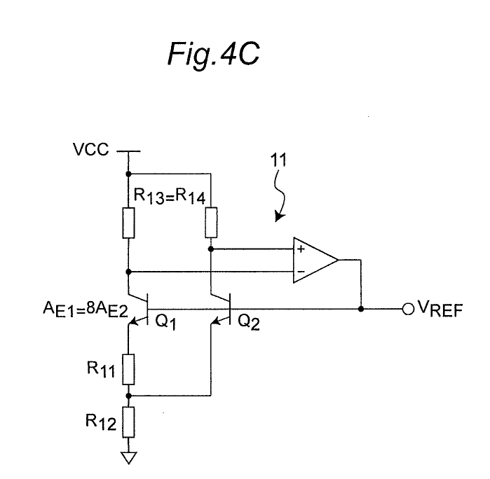

FIG. 4A shows an exemplary implementation of the ESD protection circuit 101A.

Referring to FIG. 4A, regulator 2 comprises a bandgap reference voltage circuit (BG) 11 for producing a reference voltage and operational amplifier 12 with feedback resistor 14 (having resistance R1) and resistor 15 (having resistance R2). Operational amplifier 12 with feedback resistors 14 and 15 amplifies the bandgap reference in fixed gain of (1+R2/R1).

An example of the bandgap reference voltage circuit (BG) 11 is shown in FIG. 4C. The bandgap reference voltage circuit (BG) 11 includes transistors Q1 and Q2, resistors R11, R12, R13 and R14, and an operational amplifier. The bandgap reference voltage circuit (BG) 11 is disclosed, for example, in “Analog Integrated Circuit Design” by David Johns and Ken Martin (ISBN 0-471-14448-7) under section 8.6 CIRCUITS FOR BANDGAP REFERENCES, which is herein incorporated by reference.

Also, Capacitor 16 (having capacitance C1) is an exemplary implementation of charge storage device 8. Upon power start up, capacitor 16 will be charged up until the potential across capacitor 16 becomes equal to (VREG−GND).

The ground isolation circuit 17 of the ESD protection circuit 101A comprises an NMOS transistor 18, where gate terminal 19 is connected to power supply terminal VCC 3 and source terminal 20 is connected to ground terminal GND 4. There are 2 possible cases of ESD occurrence, which could cause the differential voltage (VREG−GND) to fall below the pre-determined threshold VTH.

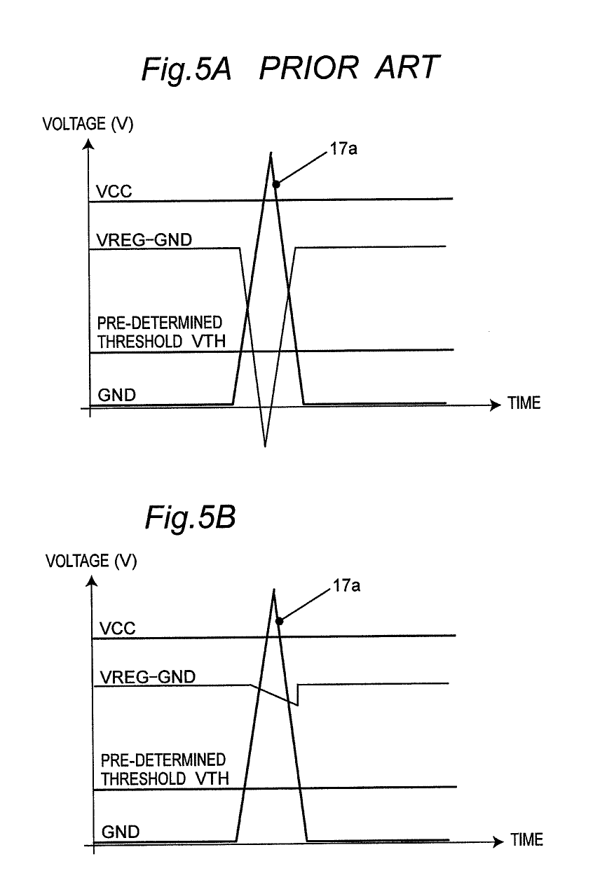

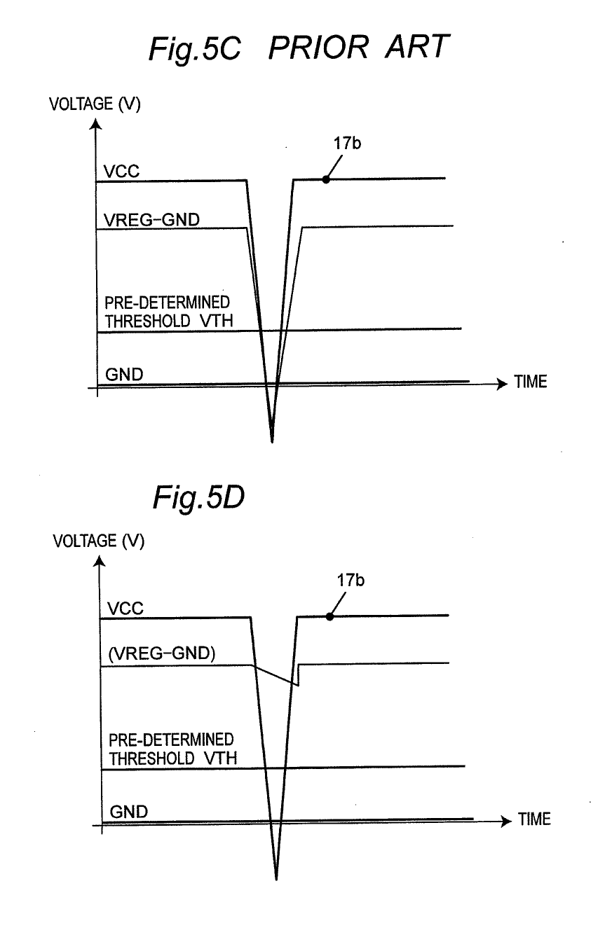

Case 1 is when the ESD occurrence causes a negative voltage spike at power supply terminal 3 (FIGS. 5C and 5D).

Case 2 is when the ESD occurrence causes a positive voltage spike at ground terminal 4 (FIGS. 5A and 5B).

For both cases 1 and 2, as gate terminal 19 and source terminal 20 of the NMOS transistor 18 are connected to power supply terminal VCC 3 and ground terminal GND 4, respectively, the voltage spike causes the voltage at NMOS gate terminal 19 to be less than the voltage at NMOS source 20. Hence, the NMOS transistor 18 is turned off, thus stopping the leakage current during ESD occurrence.

Also for case 2, the charge storage device 8 does not discharge instantaneously, as a voltage VREG at node 5 rises together with voltage at ground terminal 4. The differential voltage (VREG−GND) will be maintained at a level which is higher than the pre-determined threshold VTH. Here, charge storage device 8 may be exemplarily implemented using a capacitor 16.

Next, the designing of capacitance C1 of Capacitor 16 is explained.

When an ESD negative spike appears at power supply terminal VCC 3, NPN transistor 13 is turned off. As a result, a node VREG 5 is isolated from power supply terminal VCC 3. Also, ground Isolation circuit 17 isolates node 5 with voltage VREG from ground terminal 4. In this case, regulator 2 is unable to supply power to the load circuit 1 during the presence of the ESD negative spike. Hence, the charge stored in capacitor 16 is use to temporarily supply power to the load circuit 1. This will discharge the charge stored in capacitor 16 and cause the voltage VREG at node 5 to drop below the regulated voltage VREGN. When the negative spike is gone, the NPN transistor 13 is turned on to restart the normal operation. During a period of presence of the ESD occurrence, NPN transistor 13 is turned off to temporarily interrupt the power supply to load circuit 1. During such a period, the capacitor 16 serves as an auxiliary power source to temporarily supply power to load circuit 1, such that the charge accumulated in capacitor 16 is used for operation in load circuit 1.

It is to be noted here that the capacitance C1 of capacitor 16 should be sufficiently large to maintain the voltage (VREG−GND) there-across to be greater that the pre-determined threshold VTH at least during the period of presence of the ESD occurrence so as to ensure the normal operation of the load circuit 1.

Stored Charge Q=C1×VREG.

Hence, bigger the capacitance C1, it is possible to store more charge.

Hence, the time duration for the differential voltage to become less than the pre-determined threshold is determined by the capacitance C1 of charge storage device 8.

Another point to take note during implementation of this invention, there is certain time lag before the activation of isolation circuit 17 to turn off NMOS transistor 18 in response to the ESD occurrence. During this time lag, there is a charge leakage through isolation circuit 17.

In actual circuit implementation, it is necessary to design for this time lag to be less than a pre-determined duration, whereby the charge leakage does not cause the differential voltage (VREG−GND) to drop below the pre-determined threshold VTH.

When there is a fast turn on and off of NMOS transistor 18, there will be no such undesirable drop of (VREG−GND) during the time-lag. This can be realized by a minimization of a metal trace impedance, wherein the metal trace impedance is impedance observed between the ground isolation circuit 17 and the regulator 2; as well as impedance observed between the ground isolation circuit 17 and the ground terminal 4.

FIGS. 5A, 5B, 5C and 5D are sample waveforms to further explain function of the ground isolation circuit 17.

FIG. 5A shows sample waveforms at power supply terminal VCC 3 and ground terminal GND 4 together with the differential voltage (VREG−GND) in the case where the ground isolation circuit 17 is not used. Also, FIG. 5B shows sample waveforms at power supply terminal VCC 3 and ground terminal GND 4 together with the differential voltage (VREG−GND) in the case where the ground isolation circuit 17 is used, such as in the first embodiment.

As shown in both FIGS. 5A and 5B, there is positive spike 17a at the ground terminal 4. In the case of FIG. 5A, the differential voltage (VREG−GND) drops below the pre-determined threshold VTH during the presence of positive spike 17a occurring at the ground terminal 4 causing mal-function in load circuit 1. In the case of FIG. 5B, by implementing ground isolation circuit 17, the leakage from node 5 to ground terminal 4 is reduced to suppress the voltage drop at node 5, so that the differential voltage (VREG−GND) drops at a rate which is slower than that observed in the case of FIG. 5A. Due to the slow rate of voltage drop, the differential voltage (VREG−GND) is still maintained above the pre-determined threshold VTH even during the period of presence of the ESD occurrence, i.e., from the rising point to the returning point of the positive spike 17a occurring at ground terminal GND 4.

FIG. 5C shows sample waveforms at power supply terminal VCC 3 and ground terminal GND 4 together with the differential voltage (VREG−GND) in the case where the ground isolation circuit 17 is not used. Also, FIG. 5D shows sample waveforms at power supply terminal VCC 3 and ground terminal GND 4 together with the differential voltage (VREG−GND) in the case where the ground isolation circuit 17 is used.

As shown in both FIGS. 5C and 5D, there is negative spike 17b at the power supply terminal 3. In the case of FIG. 5C, the differential voltage (VREG−GND) drops below the pre-determined threshold VTH during the presence of negative spike 17b occurring at the power supply terminal 3 causing mal-function in load circuit 1. In the case of FIG. 5D, by implementing ground isolation circuit 17, the leakage from node 5 to ground terminal 4 is reduced to suppress the voltage drop at node 5, so that the differential voltage (VREG−GND) drops at a rate which is slower than that observed in the case of FIG. 5C. Due to the slow rate of voltage drop, the differential voltage (VREG−GND) is still maintained above the pre-determined threshold VTH even during the period of presence of the ESD occurrence, i.e., from the falling point to the returning point of the negative spike 17b occurring at power supply terminal VCC 3.

FIG. 4B shows an example of load circuit 1. The load circuit 1 comprises a logic reset signal generator 1a and logic circuit 1b. Logic reset signal generator 1a monitors the differential voltage (VREG−GND). Whenever the differential voltage (VREG−GND) drops below the pre-determined threshold VTH, logic reset signal generator 1a outputs a logic reset signal 1c to logic circuit 1b.

Logic circuit 1b is designed such that all the logic outputs 1d are reset to a default state upon receiving logic reset signal 1c. The default state is a state where all the logic output 1d is in known state and will not cause any undesired logic operation.

Generally, in a mixed signal system, the pre-determined threshold VTH is set higher than the minimum voltage level of the differential voltage (VREG−GND) which will ensure correct logic operation. Also, charge storage device 8 prevents the differential voltage (VREG−GND) from being dropped below the pre-determined threshold VTH during the presence of ESD spike by its stored charge.

In some other systems, logic reset signal generator 1a is also known as the power-on-reset (POR). The power-on-reset generates a reset signal (via logic output 1c) for the output during IC start-up.

### Second Embodiment

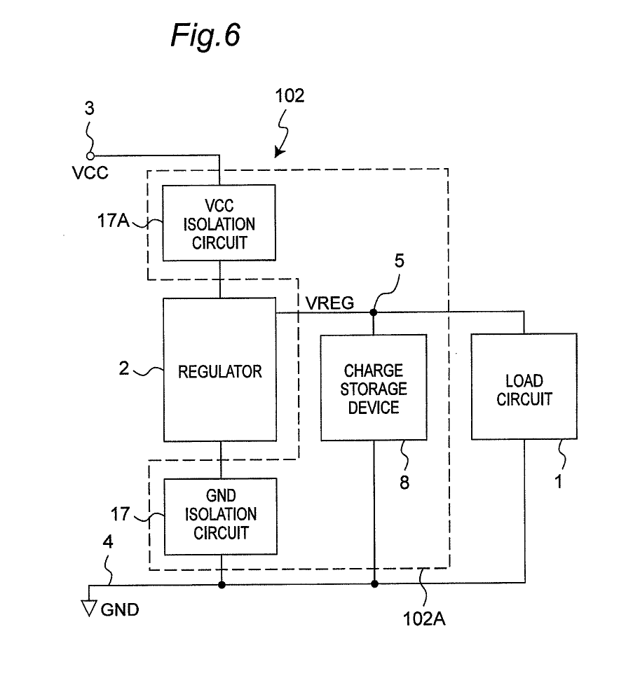

Referring to FIG. 6, the ESD protection circuit 102A of system 102 is shown. When compared with the first embodiment of FIG. 3A, the second embodiment further has a VCC isolation circuit 17A, which is also referred to as a power line isolation circuit 17A, inserted between power supply terminal 3 and regulator 2.

According to the second embodiment of the present invention, in the case of the ESD occurrence, the charge storage device 8 with a small capacitance serving as an auxiliary power supply can supply sufficient power to the load circuit 1, because the leakage current from the charge storage device 8 to the power supply terminal 3 or to the ground terminal 4 can be prevented immediately by the VCC isolation circuit 17A or by the ground isolation circuit 17, respectively, in response to the ESD occurrence either at the power supply terminal 3 or at the ground terminal 4.

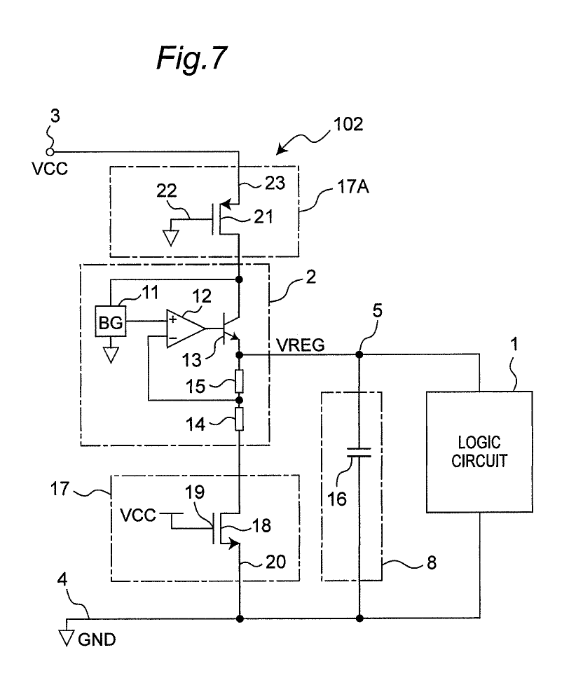

FIG. 7 shows a possible circuit to implement ESD protection circuit 102A of System 102.

Referring to FIG. 7, VCC isolation circuit 17A comprises a PMOS transistor 21, where gate terminal 22 is connected to ground terminal 4 and source terminal 23 is connected to power supply terminal 3. As mentioned in the first embodiment, there are 2 possible cases of ESD occurrence, which could cause the differential voltage (VREG−GND) to fall below the pre-determined threshold VTH.

Case 1 is when the ESD occurrence causes a negative spike at power supply terminal 3.

Case 2 is when the ESD occurrence causes a positive spike at ground terminal 4.

For both cases 1 and 2, as gate terminal 22 and source terminal 23 of PMOS transistor 21 are connected to ground terminal 4 and power supply terminal 3, respectively, the voltage at gate terminal 22 becomes higher than the voltage at source terminal 23. Hence, the PMOS is turned off to stop the leakage current from node 5 to power supply terminal 3 during ESD occurrence.

According to the second embodiment, since PMOS transistor 21 has a fast turn on and off characteristics, there will be no such undesirable drop of differential voltage (VREG−GND) during the time-lag. This can be realized by a minimization of a metal trace impedance, wherein the metal trace impedance is impedances observed between the VCC isolation circuit 17A and the regulator 2; and between the ground isolation circuit 17 and the regulator 2; as well as impedances observed between the ground isolation circuit 17 and the ground terminal 4; and between the VCC isolation circuit 17A and the power supply terminal 3.

According to the second embodiment, since the ground isolation circuit 17 and the VCC isolation circuit 17A can quickly isolate the node 5 from the ground terminal 4 and the power supply terminal 3, respectively, the leakage current from node 5 to ground terminal 4 or the power supply terminal 3 can be suppressed to maintain the voltage level at node 5 to be nearly equal to normal differential voltage (VREGN−GND) in response to the occurrence of the ESD at the ground terminal 4 or the power supply terminal 3. Thus, the capacitor 16 with a relatively small capacitance can supply power to the load circuit 1.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. An electrostatic discharge (ESD) protection circuit for use in a power supply device for supplying a DC power to a load circuit between a first power line and a second power line, said ESD protection circuit comprising:
a regulator provided between the first power line and the load circuit;
a charge storage device inserted between the first power line and the second power line; and
a second power line isolation circuit provided between the regulator and the second power line whereby the second power line isolation circuit isolates an output of the regulator from the second power line when an ESD occurs in the second power line, so as to establish a temporary power supply from said charge storage device to the load circuit.

2. The ESD protection circuit according to claim 1, wherein said second power line isolation circuit comprises a NMOS transistor, wherein a gate terminal of said NMOS transistor is connected to the first power line and a source terminal of said NMOS transistor is connected to the second power line.

3. The ESD protection circuit according to claim 2, wherein the connection between the regulator and the second power line isolation circuit is established by a low impedance metal trace connection.

4. The ESD protection circuit according to claim 3, wherein the connection between the second power line isolation circuit and the second power line is established by a low impedance metal trace connection.

5. An electrostatic discharge (ESD) protection circuit for use in a power supply device for supplying a DC power to a load circuit between a first power line and a second power line, said ESD protection circuit comprising:
a regulator provided between the first power line and the load circuit;
a charge storage device inserted between the first power line and the second power line;
a second power line isolation circuit provided between the regulator and the second power line whereby the second power line isolation circuit isolates an output of the regulator from the second power line when an ESD occurs in the second power line, so as to establish a temporary power supply from said charge storage device to the load circuit; and
a first power line isolation circuit provided between the regulator and the first power line whereby the first power line isolation circuit isolates an output of the regulator from the first power line when an ESD occurs in the first power line, so as to establish a temporary power supply from said charge storage device to the load circuit.

6. The ESD protection circuit according to claim 5, wherein said first power line isolation circuit comprises a PMOS transistor, wherein a gate terminal of said PMOS transistor is connected to the second power line and a source terminal of said NMOS transistor is connected to the first power line; and
wherein said second power line isolation circuit comprises a NMOS transistor, wherein a gate terminal of said NMOS transistor is connected to the first power line and a source terminal of said NMOS transistor is connected to the second power line.

7. The ESD protection circuit according to claim 6, wherein the connection between the first power line isolation circuit and said regulator is established by a low impedance metal trace connection.

8. The ESD protection circuit according to claim 7, wherein the connection between the first power line isolation circuit and the first power line is established by a low impedance metal trace connection.

9. The ESD protection circuit according to claim 8, wherein the connection between the regulator and the second power line isolation circuit is established by a low impedance metal trace connection.

10. The ESD protection circuit according to claim 9, wherein the connection between the second power line isolation circuit and the second power line is established by a low impedance metal trace connection.

11. An electrostatic discharge (ESD) protection method for use in a power supply device for supplying a DC power to a load circuit between a first power line and a second power line, said ESD protection method comprising:
providing a regulator between the first power line and the load circuit;
inserting a charge storage device between the first power line and the second power line; and
providing a second power line isolation circuit between the regulator and the second power line whereby the second power line isolation circuit isolates an output of the regulator from the second power line when an ESD occurs in the second power line, so as to establish a temporary power supply from said charge storage device to the load circuit.

12. An electrostatic discharge (ESD) protection method for use in a power supply device for supplying a DC power to a load circuit between a first power line and a second power line, said ESD protection method comprising:
providing a regulator between the first power line and the load circuit;
inserting a charge storage device between the first power line and the second power line;
providing a second power line isolation circuit between the regulator and the second power line whereby the second power line isolation circuit isolates an output of the regulator from the second power line when an ESD occurs in the second power line, so as to establish a temporary power supply from said charge storage device to the load circuit; and
providing a first power line isolation circuit between the regulator and the first power line whereby the first power line isolation circuit isolates an output of the regulator from the first power line when an ESD occurs in the first power line, so as to establish a temporary power supply from said charge storage device to the load circuit.
